(19) United States
(12) Patent Application Publication
(10) Pub. No.: US 2002/0084562 A1
(43) Pub. Date: Jul. 4, 2002

(54) Disk spring

(76) Inventor: Donald J. Kelsey, San Ramon, CA (US)

Correspondence Address: GRAY CARY WARE & FREIDENRICH LLP, 153 TOWNSEND, SUITE 800, SAN FRANCISCO, CA, 94107, US

(21) Appl. No.: 09/751,582

(22) Filed: Dec. 29, 2000

(51) Int. Cl. F16F 1/06

(52) U.S. Cl. 267/166

(57) ABSTRACT

A symmetrical disk-shaped spring having two or more symmetrical, spiral-shaped webs connecting inner and outer rings is disclosed. The webs are defined between symmetrical, spiral-shaped slots that extend between the inner and outer rings. The spiral-shaped webs apply axial forces when the inner and outer rings are displaced axially relative to the each other. The symmetrical disk-shaped spring is made by machining a flat, disk-shaped piece of material. The spiral-shaped slots are machined through the thickness of the material, leaving the spiral-shaped web material to connect the outer and inner rings.

### BACKGROUND OF THE INVENTION

1. Field of the Invention

This invention relates generally to springs, and relates more particularly to a disk spring having symmetrical, spiral-shaped webs that connect inner and outer rings.

2. Description of the Relevant Art

A need exists for a relatively high rate, low displacement spring that is dynamically balanced for high-speed rotation about a spin axis. One application for such a spring is in a high-speed collett mechanism or other chucking device used for spin testing disk media used in hard disk drives. The spring provides an axial force that comes into play when the collett mechanism is moved between an open position and a closed position to grasp or release the disk media. The rotational speeds for such a collett mechanism can be in excess of 10,000 revolutions per minute. At such high speeds, great care must be taken to balance all parts of the mechanism, including any springs. Coil springs are difficult to dynamically balance about a spin axis because the spring ends are not symmetrical.

One possibility for a spring for a high-speed collett mechanism is a Belleville washer, which works as a stiff spring when compressed or flattened along its axis. A Belleville washer is shaped much like a conventional washer, in the shape of a ring with an inner diameter and an outer diameter, but formed into a conical shape. Belleville washers are commonly used in applications where a stiff, low travel spring is needed. The travel of a Belleville washer is a function of its conical shape because the end of travel is reached when the washer is flattened. Multiple Belleville washers can be stacked in alternating directions to provide greater travel than a single washer or stacked in the same direction to provide greater force than a single washer.

One drawback to a Belleville washer is that it is difficult to precisely balance because the inner and outer diameters change dimensionally under load. The inner and outer diameters of a Belleville washer change slightly between the relaxed condition and the loaded condition because the orientations of the inner and outer edges change with the load. The edges of a Belleville washer are parallel to the axis when the washer is flattened, but are angled otherwise. This effect makes it difficult to precisely control the lateral position of the washer on a rotating shaft using the inner diameter or inside a rotating cavity using the outer diameter. Since the lateral position of a Belleville washer cannot be tightly controlled, it is difficult to dynamically balance the washer about the spin axis of the shaft or cavity.

### SUMMARY OF THE INVENTION

In summary, the present invention is a symmetrical disk-shaped spring that has an outer ring and an inner ring, both concentric to an axis; and two or more symmetrical, spiral-shaped webs connecting the inner and outer rings. The webs are defined between symmetrical, spiral-shaped slots that extend between the inner and outer rings. The slots stop short of the inner and outer diameters so that the inner and outer rings are continuous and unbroken. The inner and outer rings are connected by the spiral-shaped webs, which apply axial forces when the inner and outer rings are displaced axially relative to the each other.

In the illustrated embodiment, each slot is a series of connected constant-radius segments, with the radii increasing from the inner ring to the outer ring. Alternatively, each slot can have a continuously varying radius. Each web preferably has a constant width between adjacent slots. In the illustrated embodiment, there are two interspersed, symmetrical, spiral-shaped webs disposed between two slots. Each slot in the illustrated embodiment is composed of four constant-radius segments each defining one-half of a circle.

The symmetrical disk-shaped spring of the present invention is made by machining a flat, disk-shaped piece of material, which preferably is steel. The slots are machined through the thickness of the material, leaving the web material to connect the outer and inner rings. Each slot is spiral-shaped and extends between a point inward of the outer diameter and a point outward of the inner diameter. Preferably, the slots are machined by EDM—electro-discharge machining. The illustrated embodiment has a start hole at the end of each slot having a diameter slightly larger than the width of the slot. The start holes facilitate the installation and removal of an EDM machining wire.

The features and advantages described in the specification are not all inclusive, and particularly, many additional features and advantages will be apparent to one of ordinary skill in the art in view of the drawings, specification and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a plan view of a disk spring according to the present invention.

FIG. 2 is a side view of the disk spring of the present invention in a relaxed condition.

FIG. 3 is a side view of the disk spring of the present invention in a loaded condition.

### DETAILED DESCRIPTION OF THE PREFERRED EMBODIMENTS

The drawings depict various preferred embodiments of the present invention for purposes of illustration only. One skilled in the art will readily recognize from the following discussion that alternative embodiments of the structures and methods illustrated herein may be employed without departing from the principles of the invention described herein.

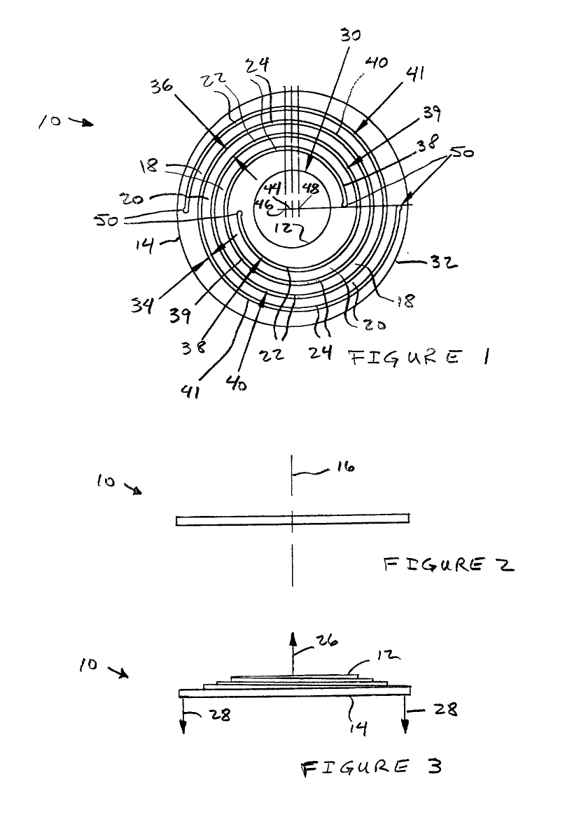

FIGS. 1-3 show one embodiment of the present invention, which is a symmetrical disk-shaped spring 10 that has an inner ring 12 and an outer ring 14, both concentric to an axis 16; and two or more interspersed, spiral-shaped, symmetrical webs 18 and 20 connecting the inner and outer rings. The webs 18 and 20 are bordered by symmetrical, spiral-shaped slots 22 and 24 that extend between the inner and outer rings 12 and 14. The slots 22 and 24 stop short of the outer and inner diameters, leaving the outer and inner rings 12 and 14 continuous and unbroken. The spring 10 is shown in a relaxed (unstressed) condition in FIGS. 1 and 2 and is shown in a loaded (stressed) condition in FIG. 3.

The inner and outer rings 12 and 14 are connected by the spiral-shaped webs 18 and 20, which deflect when the inner and outer rings are displaced relative to the each other. As shown in FIG. 3, the inner ring 12 is displaced axially relative to the outer ring 14 in response to an axial force 26 on the inner ring and a balancing axial force 28 on the outer ring. The spring 10 thus provides a spring force in response to axial displacement.

The webs 18 and 20 permit the inner and outer rings 12 and 14 to translate axially without distorting the inner diameter 30 and outer diameter 32. This facilitates a tight-tolerance mounting of the inner or outer diameter of the spring 10 in order to tightly control the radial position of the spring when rotated about the axis 16. Thus, the spring position can be tightly controlled during high speed rotation. Also note that the webs and slots are symmetrical about the axis 16, which is also important to the balance of the spring 10.

The spring 10 also can be used as a torsion spring because the inner and outer rings 12 and 14 are displaced rotationally relative to each other in response to a torsional force. The webs 18 and 20 permit limited rotation of the inner and outer rings relative to each other about axis 16.

The slots 22 and 24 preferably have a constant width 34 and are preferably arranged so that the webs 18 and 20 between the slots have a constant width 36. In the illustrated embodiment, each slot 22 and 24 extends 720° (2 turns) around the spring 10. The webs 18 and 20 in the illustrated embodiment extend about 540° (1½ turns) around the spring 10. The spring 10 can be made stiffer by reducing the spiral length of the webs, or more flexible by increasing the spiral length of the webs. Also, the spring 10 can be made stiffer by increasing the width of the webs by reducing the slot width, or more flexible by decreasing the width of the webs by increasing the slot width. Different materials and material thickness may be used to vary the spring rate; a higher modulus material or thicker material will have a relatively higher spring rate.

In the illustrated embodiment, the slots 22 and 24 are interconnected half-circle segments 38-41, each segment having a constant radius. The center of each half-circle segment is offset from the center 44 of the circle and is located at either point 46 or point 48. The four half circle segments in the upper part of the spring 10, as viewed in FIG. 1, are centered at point 46, while the four half circle segments in the lower part of the spring are centered at point 48. The distance between the points 46 and 48 is equal to the slot width plus the web width, which results in a smooth transition between each half-circle segment 38-41. The radius of each half-circle segment 38-41 increases in steps from the innermost segment 38 to the outermost segment 41. Defining the slots as a series of interconnected half-circle segments facilitates programming the machining operation that creates the slots.

Alternatively, the slots and webs therebetween may be defined in ways other than that shown in the illustrated embodiment. The slots could be defined as a continuously variable radius spiral or any other layout that results in spiral-like webs. The slots need not be constant width for the spring to function, but constant width is preferable for ease of machining and analysis. The width of the webs 18 and 20 need not be constant. Variable or non-linear spring rates may be obtained with non-constant width webs. An important consideration for rotational balance, however, is that the slots and webs be symmetrical.

The spring 10 is not restricted to just two slots and two corresponding webs, even though that is the illustrated embodiment. The primary criterion is symmetry of the slots and webs so that the spring is balanced in rotation about its axis 16. The spring could have, for example, three slots beginning and ending at points spaced 120° apart, or four slots spaced 90° apart, and so on.

The spring 10 is preferably manufactured by electro-discharge machining, EDM, which is a well known machining technique. Start holes 50 are drilled or otherwise machined before the EDM operation, then a machining wire (not shown) is inserted through a start hole and tensioned to be perpendicular to the spring and an electric current is applied. The material surrounding the machining wire is dissolved by the electrical discharge. The workpiece is moved relative to the wire to form the slots. The start holes 50 are preferably tangent to the slots so that the web width is not reduced locally.

The spring of the present invention is also not restricted to a structure that is flat when unstressed. The spring can be fabricated by starting with a conical ring segment, like a Belleville washer, and then machining the slots to form the webs. In such a configuration, flattening the spring would put it in a stressed condition.

From the above description, it will be apparent that the invention disclosed herein provides a novel and advantageous disk-shaped spring having two or more symmetrical, spiral-shaped webs connecting inner and outer rings. The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

What is claimed is:

1. A disk-shaped spring comprising:
a continuous outer ring concentric to an axis;
a continuous inner ring concentric to the axis; and
two or more symmetrical, spiral-shaped webs connecting the inner and outer rings.

2. A disk-shaped spring as recited in claim 1 wherein the webs are located between spiral-shaped slots that extend between the inner and outer rings.

3. A disk-shaped spring as recited in claim 2 wherein each slot is a series of connected constant-radius segments, and wherein the radii of the constant-radius segments increases from the inner ring to the outer ring.

4. A disk-shaped spring as recited in claim 3 wherein each slot has four constant-radius segments each defining one-half of a circle.

5. A disk-shaped spring as recited in claim 2 wherein each slot has a hole at each end thereof, wherein the hole has a diameter that is larger than the width of the slot.

6. A disk-shaped spring as recited in claim 2 wherein each web has a constant width extending between adjacent slots.

7. A disk-shaped spring as recited in claim 2 having two webs disposed between two spiral-shaped slots.

8. A disk-shaped spring comprising:
a continuous outer ring concentric to an axis;
a continuous inner ring concentric to the axis; and
two or more symmetrical spiral-shaped webs connecting the inner and outer rings, wherein the webs are located between spiral-shaped slots that extend between the inner and outer rings, wherein each slot is a series of connected constant-radius segments, wherein the radii of the constant-radius segments decreases from the outer ring to the inner ring, and wherein each web has a constant width extending between adjacent slots.

9. A disk-shaped spring manufactured by the steps of:
providing a disk-shaped piece of material having an inner diameter and an outer diameter; and
machining at least two symmetrical slots through the piece of material between the inner and outer diameters, wherein each slot is spiral-shaped and extends between a point radially outward of the inner diameter and a point radially inward of the outer diameter.

10. A disk-shaped spring as recited in claim 9 wherein each slot is a series of connected constant-radius segments, and wherein the radii of the constant-radius segments increases from the inner diameter to the outer diameter.

11. A disk-shaped spring as recited in claim 10 wherein each slot has four constant-radius segments each defining one-half of a circle.

12. A disk-shaped spring as recited in claim 9 wherein each slot has a hole at an end thereof, wherein the hole has a diameter that is larger than the width of the slot.

13. A disk-shaped spring as recited in claim 9 wherein a web is defined between adjacent slots, and wherein the web has a constant width.

14. A disk-shaped spring as recited in claim 13 having two symmetrical spiral-shaped webs disposed between two spiral-shaped slots.

15. A disk-shaped spring as recited in claim 9 wherein the step of machining the slots includes electro-discharge machining.
